(19) United States
(12) Patent Application Publication
(10) Pub. No.: US 2016/0063600 A1
(43) Pub. Date: Mar. 3, 2016

(54) COMPUTER-IMPLEMENTED METHOD OF SIMULTANEOUSLY DISPLAYING A PLURALITY OF INTERCHANGEABLE ITEMS FOR PURCHASE

(71) Applicant: Top-Line Furniture Warehouse Corp., Itasca, IL (US)

(72) Inventor: Felix Rehn-Gour Wuang, Itasca, IL (US)

(21) Appl. No.: 14/531,396

(22) Filed: Nov. 3, 2014

(30) Foreign Application Priority Data
Aug. 29, 2014 (TW) 103129958

(51) Int. Cl. G06Q 30/06

(52) U.S. Cl. CPC G06Q 30/0631

(57) ABSTRACT

A computer-implemented method, system, and software product for simultaneously displaying, via a display device, a plurality of product images based on received user selections to allow the user to visualize the appearance of plural products in combination, where at least some of the product images were captured by an image capture device and present products arranged in a non-virtual space.

### FIELD OF THE INVENTION

The present disclosure relates to the field of electronic shopping or electronic item investigation. The present disclosure also relates to a shopping interface and computer-implemented methods of improving item display within the shopping interface.

### BACKGROUND OF THE INVENTION

Consumers have many challenges when purchasing products. Any given purchase will be influenced by a host of factors, including appearance, style, price, value, and quality. A significant number of consumers, especially those searching for home furnishings, search for information online. Understanding the Furniture Purchase Decision, Franklin Furniture Institute Highlights, January 2009: Volume 7, Issue 3, p. 3, http://www.ffi.msstate.edu/pdf/highlights0109.pdf, (last visited 28 Oct. 2014) (“[T]he internet is a valuable source of information for consumers.”) A drawback of searching for home furnishings online relies in the difficulty consumers have in visualizing any particular item in the context of one's home, and in the context of surrounding items.

A driving force behind the selection of particular furniture items involves the item's aesthetics. The aesthetic effect of the item is strongly linked to the texture, color or pattern of the item. Further, the perceived color of an item can change based upon lighting conditions and the color of other items in the environment.

Presently, consumers can shop for furniture by visiting furniture showrooms, visiting big-box retailers, or shopping online using the internet. None of these present options provide sufficiently realistic representations of how an item will appear once it is placed in the consumer's home. For example, furniture showrooms may be specially designed to optimize the look and feel of a particular product, or pre-selected set of products, not to mimic actual living conditions. When the consumer places the purchased product within their home, the consumer may be dissatisfied with the appearance of the new product, either because of lighting conditions, or because of how the product coordinates, or fails to coordinate, with the pre-existing items.

Similar difficulties can occur with online shopping or investigation of other products whose purchase is strongly influenced by aesthetics, color, style, etc. For example, consumers may be disappointed by an apparel item purchased online once it is delivered and is worn with other apparel in the consumer's own home, under normal everyday lighting conditions.

There remains a need for a new and improved computer-implemented display method to overcome the problems stated above.

### SUMMARY OF THE INVENTION

The present disclosure includes a computer-implemented method of simultaneously displaying, via a display device, a plurality of product images based on received user selections to allow the user to visualize the appearance of plural products in combination.

The present disclosure also includes a visualization system for simultaneously displaying, via a display device, a plurality of product images based on received user selections to allow the user to visualize the appearance of plural products in combination. The system may comprise a user interface, a display device, a plurality of image files stored in computer memory, a computer processor communicatively coupled between the user interface, the display device and the computer memory, and a set of instructions stored in computer memory.

The present disclosure also includes software stored in a non-transitory computer-readable medium and instructions executable by a computer system.

The software and instructions enable the method that may include the steps of:

receiving, via a user interface, initial product image selection information, the initial product image selection information being comprised of information identifying a plurality of product images to be displayed via a display device;

responsive to receiving the initial product image selection information, accessing, via a computer processor, a plurality of image files, each of the plurality of image files being stored in a computer memory,
wherein each of the plurality of image files comprises at least one product image, each product image presents a product in a predetermined product position in a non-virtual product space, at least the product images being captured by an image capture device;

identifying, via a computer processor, from the plurality of image files, an initial set of product images, each product image of the initial set of product images comprising a respective product image identified in the initial product image selection information;

displaying, via a display device, a first composite image, the first composite image being comprised of the initial set of product images;

receiving, via the user interface, replacement product image selection information, the replacement product image selection information comprising:
information identifying one or more product images of the initial set of product images that have been selected by a user to be replaced, and
a respective replacement product image therefor;

responsive to receiving the replacement product image selection information, accessing, via a computer processor, the plurality of image files;

identifying, via a computer processor, from the plurality of image files, a replacement set of product images, each product image of the replacement set of product images being identified in either the initial product image selection information or the replacement product image selection information, each product image identified in the replacement product image selection information presents a replacement product in a predetermined product position in a non-virtual product space corresponding to the predetermined product position of the product presented in the product image identified in the initial product image selection information being replaced; and

displaying, via a display device, a second composite image, wherein the second composite image is comprised of the replacement set of product images.

These and other aspects of the present invention will become apparent to those skilled in the art after reading the following description of the preferred embodiments, when considered in conjunction with the drawings. It should be understood that both the foregoing general description and the following detailed description are explanatory only and are not restrictive of the invention as claimed.

### BRIEF DESCRIPTION OF THE DRAWINGS

FIG. 1 illustrates a flow diagram of a display method, according to embodiments of the present disclosure.

FIG. 2 illustrates a schematic view of a first step in an image capture process, according to embodiments of the present disclosure.

FIG. 3 illustrates a schematic view of a second step in an image capture process, according to embodiments of the present disclosure.

FIG. 4 is a schematic view of a third step in an image capture process, according to embodiments of the present disclosure.

FIG. 5 is a first schematic view of a user interface and product display, according to embodiments of the present disclosure.

FIG. 6 is a second schematic view of a user interface and product display, according to embodiments of the present disclosure.

FIG. 7 is a third schematic view of a user interface and product display, according to embodiments of the present disclosure.

FIG. 8 is a diagram illustrating exemplary hardware and software components that may be used to implement some embodiments of the present disclosure.

### DETAILED DESCRIPTION OF THE INVENTION

The following detailed description is provided as an enabling teaching of embodiments of the present disclosure. Those skilled in the relevant art will recognize that many changes can be made to the embodiments described, while still obtaining the beneficial results. It will also be apparent that some of the desired benefits of the embodiments described can be obtained by selecting some of the features of the embodiments without utilizing other features. Accordingly, those who work in the art will recognize that many modifications and adaptations to the embodiments described are possible and may even be desirable in certain circumstances. Thus, the following description is provided as illustrative of the principles of some preferred embodiments and not in limitation thereof, since the scope of the invention is defined by the claims.

Reference will now be made in detail to some presently preferred embodiments, one or more examples of which are illustrated in the accompanying drawings. Each example is provided by way of explanation, and not limitation of the invention. In fact, it will be apparent to those skilled in the art that modifications and variations can be made in the present disclosure without departing from the scope or spirit thereof For instance, features illustrated or described as part of one embodiment may be used on another embodiment to yield a still further embodiment. Thus, it is intended that the present disclosure cover such modifications and variations as come within the scope of the appended claims and their equivalents.

As used herein, the terms “items”, “objects”, “elements”, “products”, and “articles”, may be used interchangeably to reference individual purchasable pieces. Purchasable pieces may be in the area of home furnishings: such as sofas, chairs, tables, lamps, pillows, artwork, window treatments, etc., the area of apparel, or any other purchasable item where appearance of the piece may play a role in the purchasing decision. As used herein, the terms “real” and “non-virtual” may be used interchangeably to describe pre-existing pieces manufactured from tangible materials, or actual physical environments defined by tangible materials.

The present disclosure provides a computer implemented method of simultaneously displaying multiple articles on a display device to allow a customer to visualize a combination of articles so that the customer can make an informed decision about the purchase of one or more of the combination of articles. Each of the multiple articles being displayed may be replaced or exchanged with two or more options. The two or more options for each article may be similar articles with different colors, patterns, finishes, or styles. In other embodiments, a first type of article, such as a bed, may be replaced by a second type of article, such as a sofa. In some embodiments, the exchange of one article for another is a substantially direct exchange, where the second article is viewed within the displayed composite image at substantially the same location from which the first article was removed. In other embodiments, one or more of the plurality of articles may be removed completely from the displayed image so that only a background scene is visible at certain locations of the displayed image. By displaying a plurality of interchangeable articles, the consumer may be able to better visualize and customize a combination of articles to their liking.

Some embodiments of the present disclosure include an image capture step. The image capture step may include photographing or videotaping, using an image capture device, of real objects arranged within a real space at predetermined locations relative to the image capture device. In some embodiments, the image capture device is a digital camera capable of capturing still images or video. The photographing or videotaping may occur under predetermined lighting conditions provided by prearranged light fixtures. In some embodiments, the light fixture locations may remain fixed, but the amount, or color, of the light may be adjusted to optimize the appearance of the real objects being photographed. Capturing photographs of real objects allows for a presentation upon a display that is more life-like than similar images created by graphic rendering. In some embodiments, the image capture device captures a photograph in a digital form such as a file. As used herein, files containing photographic images may be referred to as photograph files. Each photograph file may be stored in computer memory.

The image capture step may include the capture of a series of photographs of the real objects within the real space. Each individual photograph may include a unique combination of real objects. The unique combinations can be created by replacing an original object, which is at least one of the real objects in a previously captured photograph, with a replacement object, the replacement object being an object that is different than the original object, but is placed in the same predetermined location as the original object. Each separate photograph may be captured under the same predetermined lighting conditions. Alternatively, each separate photograph may be captured under varied lighting conditions with fixed-location light fixtures. In some embodiments, each individual real object to be displayed is captured within at least one photograph. In some embodiments, each individual real object is captured within only one photograph, particularly if the quantity of options for each predetermined location is the same. By using real objects, whose appearance is captured within a real space, the color is more natural in the photograph. By capturing objects in a predetermined arrangement, using lighting and image capturing devices in predetermined locations, deviations caused by changes in viewing perspective or relative changes in size caused by differences in distance from the image capture device can be reduced or eliminated. Because of these predetermined and fixed arrangements, captured images do not have to necessarily be re-sized to allow for deconstruction and reconstruction of various portions of each image in order to maintain an accurate representation of the relative size of each object within the image.

After capturing at least one photograph of each real object, a post-production process may be applied to each photograph. The post-production process allows the selective combination of portions of separate photographs. The post-production process may create component-image files corresponding to each individual object present in the photograph of each photograph file. The component-image files may be tagged, indexed, and stored in a database. The component-image files may then be accessed, retrieved, recombined, and displayed “on the fly” in response to computer readable instructions. Alternatively, the post-production process may use the component-image files to create a composite-image file for each of the possible combinations of individual object images, and storing the composite-image files in non-volatile member, thereby producing a complete set of files capable of being separately displayed based upon the selections of a user.

A calculation module may be used to display the proper composite image based upon a user's selections. The calculation module may retrieve the individual user selected objects, e.g. component-image files, from the database, in response to the user's actions within a user interface. Alternatively, the calculation module may retrieve the single stored composite-image file that has an image of the set of objects selected by the user. The calculation module, which is executed by a computer processor, may interact with a display device to present a compilation of images combined from separate component-image files, the images arranged at locations corresponding to the distance from the image capture device used during the image capture step. Similarly, the display device may present the image from the single composite-image file having the similarly arranged images of the desired products.

A user interface allows selective replacement, within the display, of each object, at each product location. The product location may be predetermined, or placeable in a location selected by the user. The user interface may include one or more drop-down menus. In one embodiment, a drop-down menu is provided for each product location, respectively. Therefore, each drop-down menu has different styles, colors, finishes, or types of the articles for the user to select to be displayed at a given location.

In some embodiments, a computer-implemented method of simultaneously displaying, via a display device, a plurality of product images based on received user selections is provided to allow the user to visualize the appearance of plural products in combination. In some embodiments of the proposed method, the image capture step and some, or all, of the post-processing step may pre-exist certain embodiments of the method of displaying.

In some embodiments, the method may begin with a computer receiving, via a user interface, initial product image selection information, the initial product image selection information provides information identifying a plurality of product images to be displayed via a display device. Then, responsive to receiving the initial product image selection information, the computer may access a plurality of image files, each of the plurality of image files being stored in a computer memory. The image files may be equivalent to the component-image files or may be equivalent to the composite-image files discussed above. Again, each of the plurality of image files includes at least one product image, and each product image presents a product in a predetermined product position in a non-virtual product space. Preferably, the product images were captured by an image capture device.

Next, the computer may identify, from the plurality of image files, an initial set of product images, each product image of the initial set of product images comprising a respective product image identified in the initial product image selection information.

After the initial set of product images is identified, they may be displayed in the form of a composite image on a display device, such as a monitor, hand-held screen or projected onto a surface. The composite image may include the initial set of product images arranged in a manner that maintains the product position corresponding with each product image.

The computer may then receive, via the user interface, replacement product image selection information input by a user. The replacement product image selection information can provide information identifying one or more product images of the initial set of product images that have been selected by a user to be replaced. The replacement product image selection information can also include the respective replacement product image therefor.

Responsive to receiving the replacement product image selection information, the computer may re-access the database or memory having the plurality of image files and identify a replacement set of product images. Each product image of the replacement set of product images can be identified by either the initial product image selection information, or the replacement product image selection information. Each product image identified in the replacement product image selection information presents a replacement product in a predetermined product position corresponding to the predetermined product position of the corresponding initial product being replaced.

The computer may then display, via the display device, a second composite image in a manner similar to the display of the first composite image, wherein the second composite image is comprised of the replacement set of product images.

In addition to displaying product images, the composite images may include backdrop. The backdrop may be predetermined or may be selected by the user. Preferably, the backdrop is also captured by an image capture device.

More specifically, in some embodiments, the background upon which a product image may be placed is selected among several pre-loaded backdrops. Examples can include one or more layouts of a living room, den, family room, kitchen, bedroom, or other interior or exterior location. In some embodiments, the user can upload an image from any selected environment, allowing the user to then place a product image under consideration directly in the location in the uploaded environment. Further, the uploaded image can be enhanced using user-selected or automatic settings to adjust for features such as light attributes such as exposure, highlights, shadows, brightness, contracts and black point, as generally known in the art. Adjustments for color in the area of saturation, contrasts and casts can also be selected or automatically applied, as generally known in the art. Once such adjustments are made, similar settings can be applied to the product image to enhance correlation between the product image and the uploaded environment for optimal viewing.

Therefore, some embodiments of the present disclosure include having the computer receive, via the user interface, a backdrop selection, wherein a composite image can include product images displayed relative to the selected backdrop image.

In some embodiments, receipt of a specific backdrop selection may trigger the computer processor to adjust the options within the user interface to narrow the available initial or replacement product image selection information. Effectively, this narrows the plurality of original image files. By way of example, if the backdrop selection indicates a living room, the product image selection information will be adjusted so that beds are not available products.

In order to further understand the goal, characteristics and effect of the present disclosure, a number of embodiments along with the drawings are illustrated as follows:

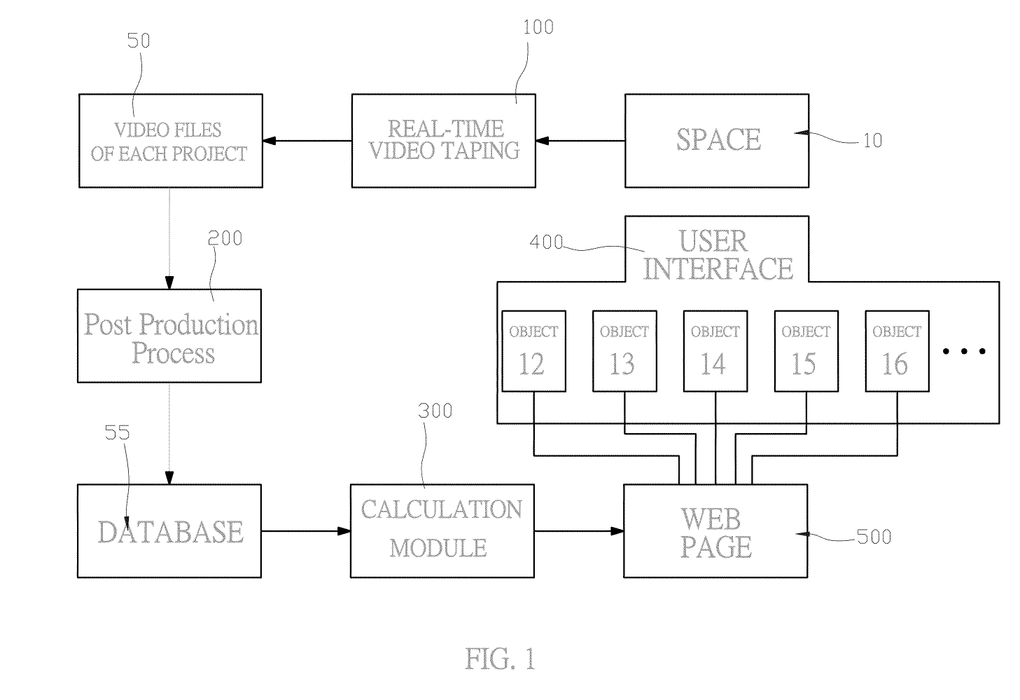

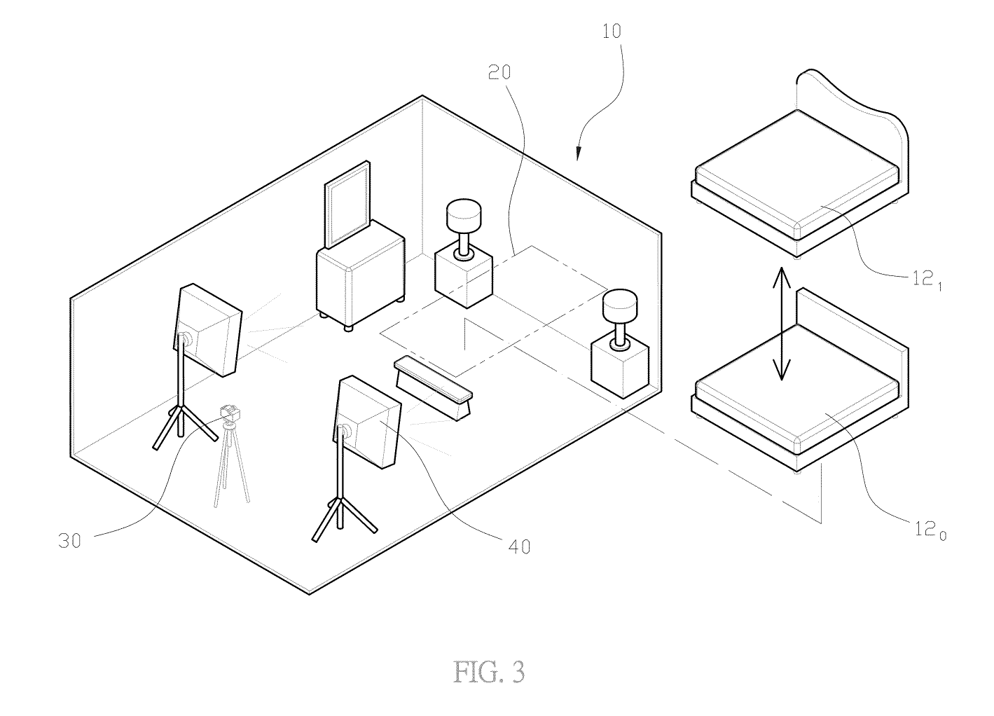

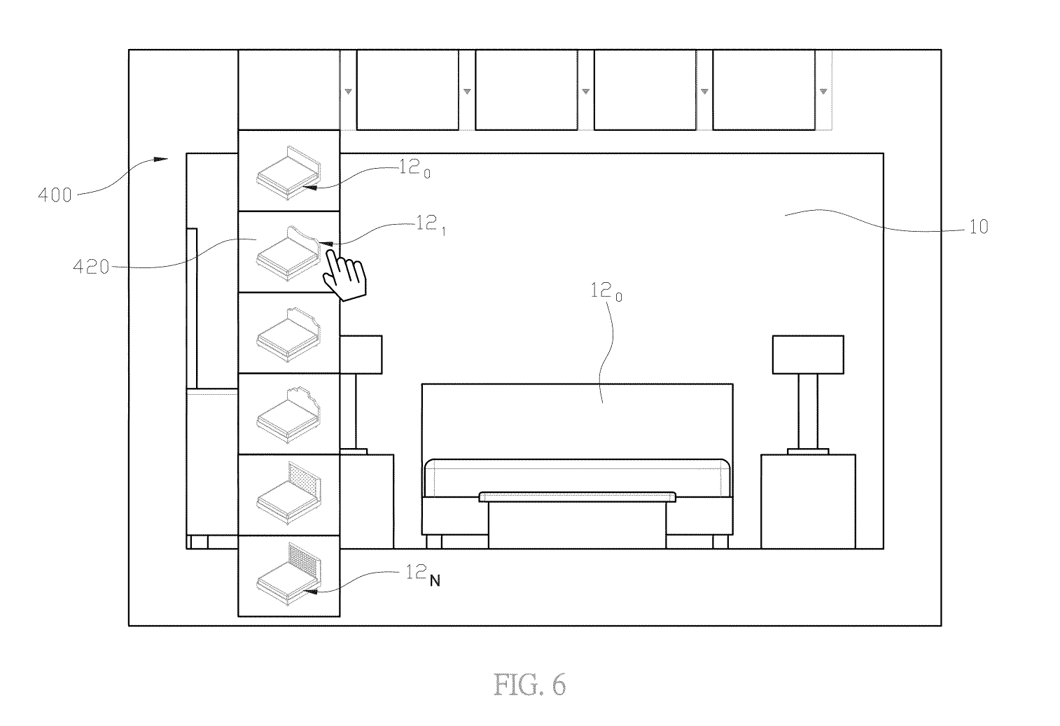

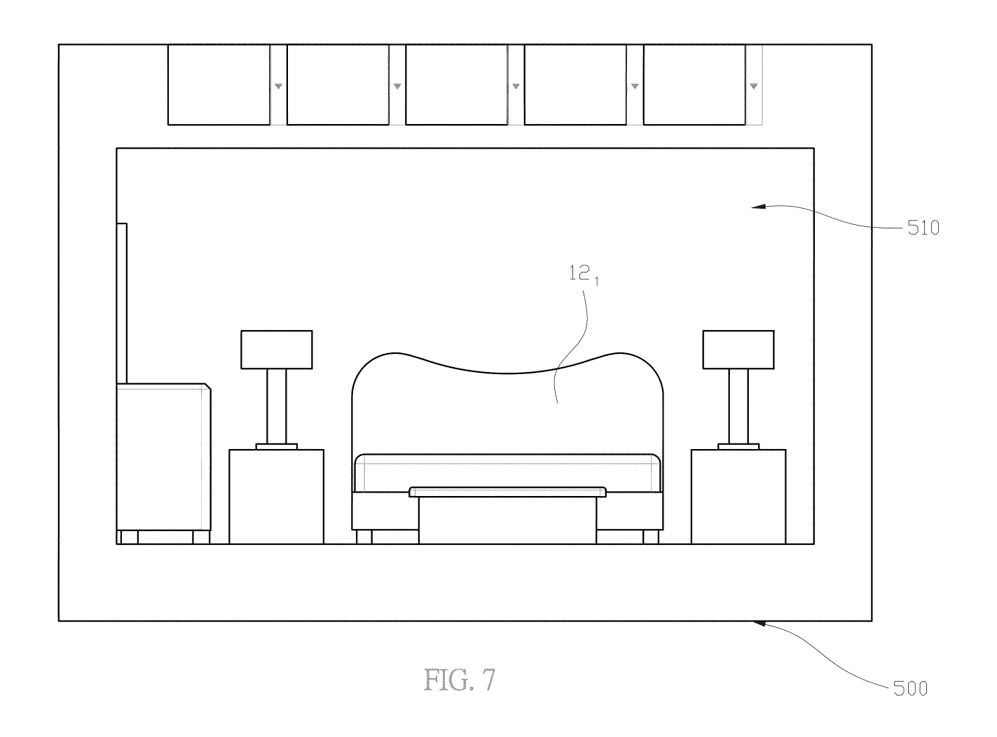

Referring to FIGS. 1 to 7, a method of displaying a customized plurality of products can be realized. Initially, a space 10, such as a room, may be set up with a plurality of initial objects 12-16 positioned in a plurality of predetermined locations 20. One of the predetermined locations 20 is outlined in FIG. 3. The space 10 can be a home space, such as living room, bedroom, bathroom or kitchen. In another embodiment, the space 10 can be a warehouse, office space, building, showroom, dressing room or inside a car, ship or airplane. The space 10 may be permanently of the types described, such as a bedroom within a house, or the space 10 may be temporarily configured to provide the desired appearance.

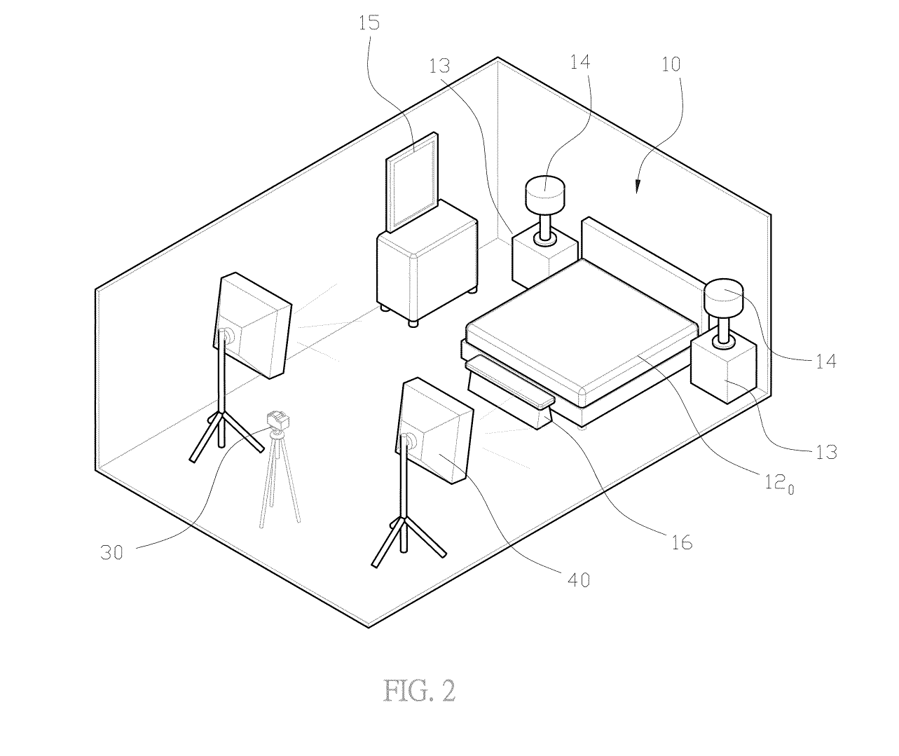

Each object 12-16 can be positionable into a select one or more of the predetermined locations 20. For example, FIG. 2 shows a bed (object 12) that would be insertable into a single predetermined location. FIG. 2 also shows a pair of side tables (objects 13). The side tables may be insertable as a pair into a single predetermined location 20, which could be considered as containing two sub-locations, or the side tables may be individually insertable into a pair of predetermined locations 20.

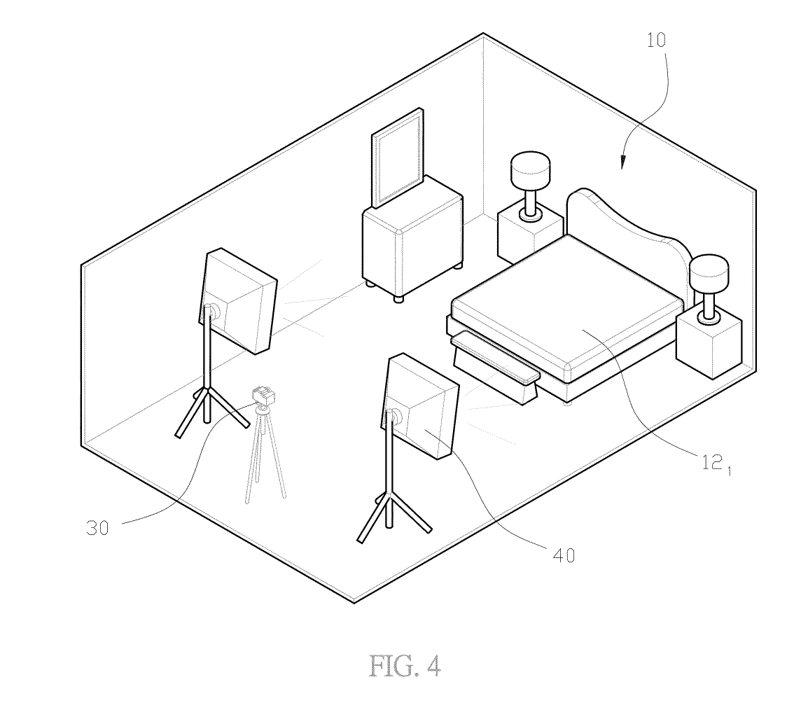

The method may include an image capture process 100 that may include providing an image capture device 30 and at least one light fixture 40 at fixed locations relative to the predetermined locations 20 and the objects 12-16 thereat. The image capture device 30 can capture a photograph or video of the initially arranged set of objects 12-16 (see FIG. 2). Then one or more of the initial objects 12₀ may be replaced with one or more new objects 12₁ at the same predetermined location 20, as shown in FIG. 3. Without moving the image capture device 30 or the light fixtures 40, a second photograph is captured of the second set of objects containing the at least one new object 12₁, as shown in FIG. 4. The process of replacing objects 12 and capturing photographs continues until each object 12₀₋ₙ-16₀, has been captured in at least one photograph. A photograph may also be captured of the space 10 without any objects 12-16 present. In some embodiments, at least two unique objects, in terms of color, pattern, style, type, finish, etc., are captured at each predetermined location 20. In other words, each object 12-16 has both an initial and at least one new version. By maintaining the objects 12-16 within the predetermined locations only, a photograph or video of each version of each object 12-16 can be captured with the proper lighting and angle to maintain consistency among the images.

The image capture device 30 may be configured to create and store a separate photograph file 50 for each capture. After creating the set of photograph files 50, a post-production process 200 may be applied to each photograph file 50. The post-production process 200 can edit, or modify the photograph files 50 so that the individual objects 12-16 in each image can be separated and indexed using a parameter setting so that component-images can be overlapped and re-combined in different life-like combinations. The resulting component-image files may be saved in a database 55. The post-production process 200 may continue by mixing and matching the individual product images within separate component-image files to create composite images in the form of composite-image files. A complete set of composite-image files may be stored in the database 55.

In the illustrated example, there are five initial objects 12-16, each with a respective predetermined location 20. If there are a total of five options for each location (e.g., five lamp styles, or four lamp styles and the option to omit lamps), there would be 3125 or 5⁵ composite images to create a full set of composite images. Each of the composite images may be stored in the database 55 in the form of a composite-image file. Put another way, the composite images can be created prior to a request by a user or “on the fly” upon request by a user.

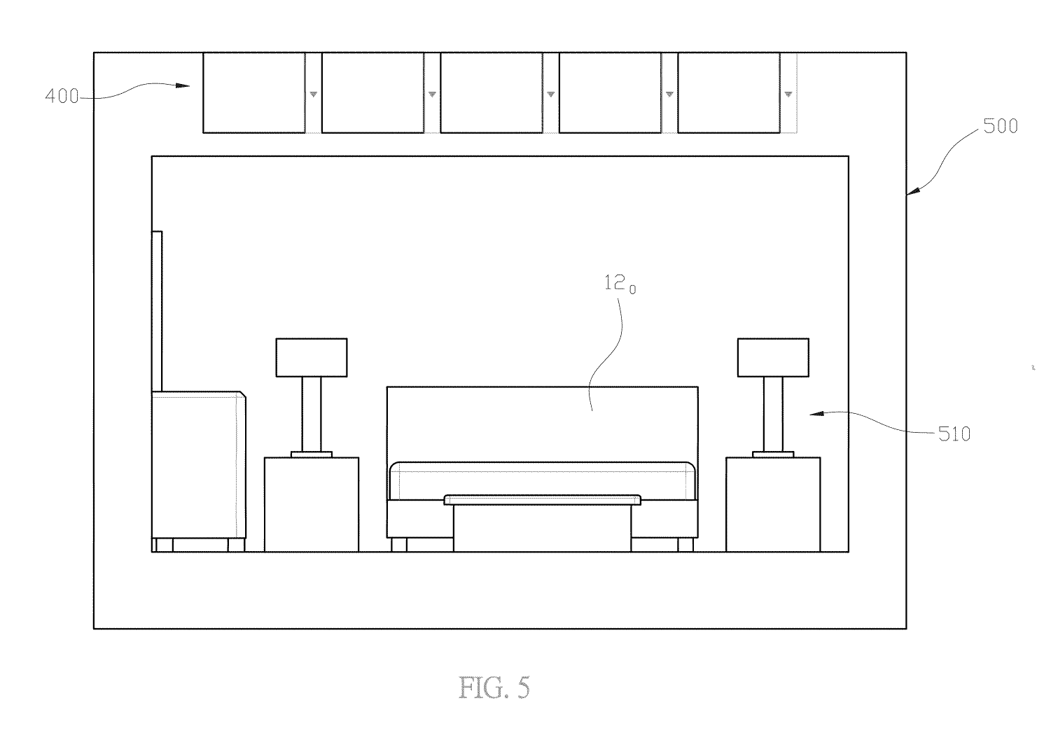

In a calculation module 300, performed on a computer processor, each of the separate component-image files can be retrieved from the database 55 and combined “on the fly” based upon the user's inputted product image selection information provided through a user interface 400. Alternatively, the calculation module 300 can call up the desired composite-image file on the database 55. As seen in FIG. 5, the user interface 400 may be displayed upon a computer monitor or similar digital screen as part of a page 500. The user interface 400 may be displayed along with a composite image 510 corresponding with the user's sections displayed in the user interface portion of the page 500. In some embodiments, the composite image 510 may be created solely of product images captured from real objects and real backgrounds. In other embodiments, the composite image 510 may be created from product images captured from real objects in combination with a graphically created backdrop. While it is preferred that each purchasable item shown within the composite image 510 should be the result of a captured real object, some of the purchasable items shown may have been graphically rendered.

The user interface 400 may include a drop-down menu 420 corresponding to each of the predetermined locations 20. In the illustrated example, FIGS. 5-7 show five drop-down menus 420. Each of the five menus 420 respectively correspond to objects 12-16 shown in FIGS. 1-4. In some embodiments, each menu 420 includes a list of options for the objects 12₀₋ₙ associated with the respective predetermined location 20. Again, by way of the illustrated example, a menu 420 corresponds to the predetermined location 20 for beds. The menu 420 then lists or otherwise shows images for the set of beds available for that location. Therefore, the user can replace an original object 12₀ with a new object 12₁ through the user interface 400. The composite image 510 displayed on the page 500 can be substantially instantly updated with the new combination of objects if reasonable computing power and/or signal transmission speed is provided.

In some embodiments, the disclosed method may involve the interne, or other computer network, where at least one of the database 55, a processor running the calculation module 300, and a display device for the page 500 are remote from one another. In some embodiments, the methods of this disclosure may be adapted for use without a network. For example, the consumer may be operating a terminal within a retail location already configured to perform at least the calculation module 300. In some embodiments, the display device may be of sufficient size and configuration to allow the composite image 510 to be projected in a life-size manner. A retailer may place such a large display device (e.g. a projector and a screen) within their store to allow their customers an opportunity to experience images of their products in full-size visualizations to assist with the customer's purchase decisions.

The present disclosure is advantageous because when the angle of the image capture device 30 and the predetermined locations 20 are unchanged, product images, within component-image files retrieved from the database 55, can be replaced and substituted without substantial reformatting of the component-image files for use in the displayed composite image 510. Further, the present disclosure is advantageous because the display presented to the user may combine images captured from pre-existing tangible objects to provide enhanced realism compared to virtually generated representations of purchasable pieces. The methods of the present disclosure also simplify the user's purchasing process to save the user's time and provide a convenient and simple purchasing platform by using a predetermined arrangement of a plurality of items.

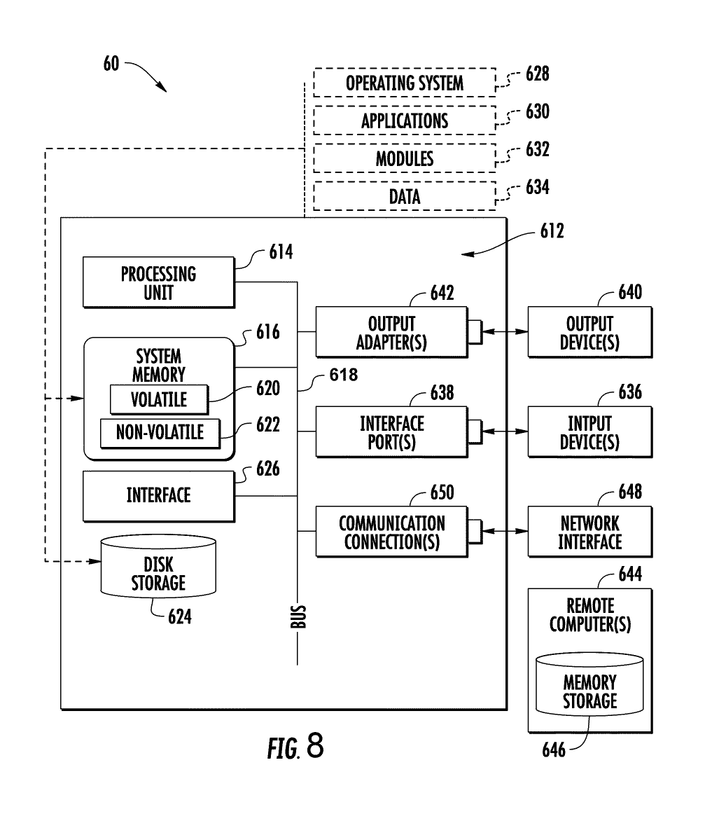

FIG. 8 illustrates exemplary hardware and software components that may be used to implement embodiments of the present disclosure. While aspects of the disclosed embodiments may be described in the general context of computer-executable instructions, such as program modules, executed by one or more computers or other devices, those skilled in the art will recognize that embodiments of the invention can also be implemented in combination with other program modules and/or as a combination of hardware and software.

Generally, however, program modules include routines, programs, objects, components, data structures, etc. that can perform particular tasks or implement particular data types. The operating environment 60 is an exemplary suitable operating environment and does not limit the scope of the present disclosure. Other known computer systems, environments, and/or configurations may be suitable for use with the embodiments.

Referring to FIG. 8, an exemplary operating environment 60 for implementing various aspects of the embodiments disclosed includes a computer 612, which includes a processing unit 614, a system memory 616, and a system bus 618. The system bus 618 couples the system components, including the system memory 616, to the processing unit 614. The processing unit 614 can be any of various processors available. The system bus 618 can be any of the available types of bus structures using any variety of available bus architectures. The system memory 616 includes volatile memory 620 and non-volatile memory 622.

Computer 612 also may include removable/non-removable, volatile/non-volatile computer storage media, for example, disk storage 624. Disk storage 624 may be connected to the system bus 618 via removable or non-removable interface 626.

FIG. 8 also illustrates software that allows interaction between users and computer resources, which may include an operating system 628. System applications 630 are allocated resources by operating system 628 through program modules 632 and program data 634 stored either in system memory 616, or on disk storage 624. Aspects of the disclosed embodiments may be implemented with various operating systems or combinations of operating systems.

A user enters commands or information into computer 612 through input devices 636, which connect to processing unit 614 through the system bus 618 via interface ports 638. Input devices may include tablets, touch screens, keyboards, scanners, etc., which can be used to input data. Output devices 640 use some of the same types of ports as input devices 636. Output adapters 642 may be provided because some output devices 640 like monitors, speakers and printers require special adapters. Other devices and/or systems of devices provide both input and output capabilities, such as remote computers 644.

Computer 612 can operate in a network environment using logical connections to one or more remote computers, such as remote computers 644. The remote computers 644 can be a personal computer, a server, a router, a network PC, a workstation, a microprocessor-based appliance, a peer device or other common network node, which may include many or all of the elements of computer 612. While only a single memory storage device 646 is shown, remote computers 644 may be logically connected to computer 612 through a network interface 648 and physically connected via communication connections 650.

The corresponding structures, materials, acts, and equivalents of all means plus function elements in any claims below are intended to include any structure, material, or acts for performing the function in combination with other claim elements as specifically claimed. Those skilled in the art will appreciate that many modifications to the exemplary embodiments are possible without departing from the scope of the present disclosure.

In addition, it is possible to use some of the features of the embodiments disclosed without the corresponding use of the other features. Accordingly, the foregoing description of the exemplary embodiments is provided for the purpose of illustrating the principles of the invention, and not in limitation thereof, since the scope of the invention is defined solely by the appended claims.

Other related embodiments of the present disclosure may be understood based upon the following additional details. Other embodiments include a method of replacing virtual articles with multiple options by using a space with a predetermined distance to insert each object. Through real-time videotaping, the series of each object is replaced, videotaped, and obtained. After receiving each video file of each object, post-production processes and calculations are used to present and replace the video files to achieve the method of replacing virtual articles, wherein the predetermined distance is determined in the space for each object, and a videotaping device and a lighting lamp are provided for the real-time videotaping. Each object is placed at the predetermined distance in the space, and through adjustment of the videotaping equipment and the lighting lamp, each object can be videotaped with a proper lighting and angle. Also, the object has several different styles, which will be videotaped at the predetermined distance to further obtain the video files in the space. When conducting the real-time videotaping, the same angle and lighting would be used for the space without introducing any objects, and the videotaping files will be sent through the post-production process to modify the video files. Furthermore, the object at the identical position can be retrieved to form a uniform video file, so the images for the object can be overlapped. Finally, all video files will be collected, complied and saved in a database.

The calculations allow for all series and styles of the objects to be selected and combined through a parameter setting of the object, so that the video file can be displayed on a page. Also, through the retrieval of the object in the video files, when it is displayed on the page, the object can be instantly replaced in the space of the page because each object is videotaped with the same angle, wherein the video files are displayed on the page on a computer monitor or display, and the calculations are performed on a computer program or algorithm of website parameters. The page has a selection interface so the user can replace the object through the selection interface. Also, the selection interface includes a drop-down menu for each object. For example, the drop-down menu has different styles of the objects for the user to select.

In embodiments where the positions of the videotaping equipment and lighting lamp are fixed, the angle for each object in the space in the video files is identical; and the lighting lamp can be adjusted according to different objects to generate better light and shade effect, to further provide a better visual effect to the user. Because the videotaping angle may be identical and through the modification of the image of each object in the video files, each object can be replaced and overlapped. The user can also choose the preferred object in the space through the selection interface to show on the page to enhance the visual effect of object in space.

Methods according to these additional embodiments may be described according to the following paragraphs:

A method of replacing virtual objects with multiple options comprising steps of:

providing a real space, wherein the real space has a plurality of objects in predetermined positions, and a lighting lamp and videotaping apparatus are positioned in the real space;

videotaping the objects in the real space, wherein a portion of the objects are disposed at predetermined positions and the lighting lamp and videotaping apparatus are used to provide proper light and an identical angle for videotaping, wherein each object has several series and styles which are all videotaped to obtain the video files of all combination of the objects in the real space;

processing the video files through post-production, wherein each video files are further retrieved, modified, complied and saved in a database; and

conducting modulus calculation, wherein all series and styles of the objects are selected and combined through a parameter setting of the object, so that the video file are displayed on a page through the module calculation, and through the retrieval of the object in the video files, when it is displayed on the page, the object is able to be instantly replaced in the space of the page because each object is videotaped with the same angle and is able to be replaced.

The method of replacing virtual objects with multiple options of the preceding paragraph, wherein the real space without the objects is videotaped.

The method of replacing virtual objects with multiple options according to the preceding paragraphs, wherein the real space is a home space, such as living room, bedroom, bathroom or kitchen; or a warehouse, office space, building, show room; or inside the car, ship or airplane.

The method of replacing virtual objects with multiple options according to the preceding paragraphs, wherein the video files are displayed on the page on a computer monitor or display through the module calculation, and module calculation is generated through computer program or algorithm of website parameters, and the page has a selection interface so the object is replaced through the selection interface.

The method of replacing virtual objects with multiple options according to the preceding paragraphs, wherein the selection interface includes a drop-down menu for each objects for the user to select.

The method of replacing virtual objects with multiple options according to the preceding paragraphs, wherein when the object is retrieved and modified in the video file, the object at the same position are retrieved with the same size, so the object is able to be overlapped.

Although the above disclosure has been presented in the context of exemplary embodiments, it is to be understood that modifications and variations may be utilized without departing from the spirit and scope of the invention, as those skilled in the art will readily understand. Such modifications and variations are considered to be within the purview and scope of the appended claims and their equivalents.

What is claimed is:

1. A computer-implemented method of simultaneously displaying, via a display device, a plurality of product images based on received user selections to allow the user to visualize the appearance of plural products in combination, the method comprising:
receiving, via a user interface, initial product image selection information, the initial product image selection information being comprised of information identifying a plurality of product images to be displayed via a display device;
responsive to receiving the initial product image selection information, accessing, via a computer processor, a plurality of image files, each of the plurality of image files being stored in a computer memory,
wherein each of the plurality of image files comprises at least one product image, each product image presents a product in a predetermined product position in a non-virtual product space, at least the product images being captured by an image capture device;
identifying, via a computer processor, from the plurality of image files, an initial set of product images, each product image of the initial set of product images comprising a respective product image identified in the initial product image selection information;
displaying, via a display device, a first composite image, the first composite image being comprised of the initial set of product images;
receiving, via the user interface, replacement product image selection information, the replacement product image selection information comprising:
information identifying one or more product images of the initial set of product images that have been selected by a user to be replaced, and
a respective replacement product image therefor;
responsive to receiving the replacement product image selection information, accessing, via a computer processor, the plurality of image files;
identifying, via a computer processor, from the plurality of image files, a replacement set of product images, each product image of the replacement set of product images being identified in either the initial product image selection information or the replacement product image selection information, each product image identified in the replacement product image selection information presents a replacement product in a predetermined product position in a non-virtual product space corresponding to the predetermined product position of the product presented in the product image identified in the initial product image selection information being replaced; and
displaying, via a display device, a second composite image, wherein the second composite image is comprised of the replacement set of product images.

2. The method of claim 1, wherein each image file comprises a plurality of product images and each composite image is composed from a single image file.

3. The method of claim 2, further comprising creating the plurality of image files, wherein the step of creating the plurality of image files comprises:
receiving, via an image capture device, a first photograph file, the first photograph file comprising an image of an initial plurality of products, including a first initial product, arranged in a non-virtual space;
storing the first photograph file in a computer memory;
receiving, via an image capture device, a second photograph file, the second photograph file comprising an image of a second plurality of products, the second plurality of products comprising at least a first replacement product, wherein the first replacement product is presented instead of, and in substantially the same position as, the first initial product, and wherein the first replacement product is a different color, pattern, style or type than the first initial product;
storing the second photograph image in a computer memory;
generating, via a computer processor, a plurality of component-image files, each of the plurality of component-image files presenting one of the products provided in the first photograph file or second photograph file, respectively; and
generating each of the plurality of image files by compiling, via the computer processor, a unique combination of component-image files such that no combination of component-image files includes both an initial and a corresponding replacement product component-image file.

4. The method of claim 3, wherein the plurality of component-image files are not re-sized relative to one another to create the image files.

5. The method of claim 1, wherein each image file comprises an image of a single product and each composite image is composed from a plurality of image files.

6. The method of claim 5, further comprising creating the plurality of image files, wherein the step of creating the plurality of image files comprises:
receiving, via an image capture device, a first photograph file, the first photograph file comprising an image of an initial plurality of products, including a first initial product, arranged in a non-virtual space;
storing the first photograph file in a computer memory;
receiving, via an image capture device, a second photograph file, the second photograph file comprising an image of a second plurality of products, the second plurality of products comprising at least a first replacement product, wherein the first replacement product is presented instead of, and in substantially the same position as, the first initial product, and wherein the first replacement product is a different color, pattern, style or type than the first initial product;
storing the second photograph file in a computer memory;
extracting, from the first and second photograph files, the plurality of image files, via a computer processor, such that each of the plurality of image files comprises an image of one of the products displayed in the first photograph file or second photograph file, respectively.

7. The method of claim 5, wherein the plurality of image files are not re-sized relative to one another to create each composite image.

8. The method of claim 1, wherein the initial product image selection information is predetermined within the user interface.

9. The method of claim 1, wherein the initial product image selection information is determined by a user prior to displaying the first composite image.

10. The method of claim 1, further comprising:
receiving, via the user interface, a backdrop selection, wherein at least the first composite image comprises the initial products displayed relative to the selected backdrop.

11. The method of claim 10, wherein receipt of the backdrop selection reduces the plurality of image files capable of being accessed, and narrows the possible replacement product selections.

12. The method of claim 10, wherein the backdrop selection comprises selection between several rooms of a residence or commercial building.

13. The method of claim 12, wherein the products are furniture pieces appropriate for the selected room.

14. The method of claim 1, wherein each composite image is displayed adjacent to and simultaneously with the user interface.

15. The method of claim 1, wherein the user interface includes one or more drop-down menus, the drop-down menus providing for a section between at least the initial product image selection information and the replacement product image selection information.

16. The method according to claim 1, wherein displaying each composite image includes displaying the composite image such that the products appear life-size.

17. A visualization system for simultaneously displaying, via a display device, a plurality of product images based on received user selections to allow the user to visualize the appearance of plural products in combination, the system comprising:
a user interface;
a display device;
a plurality of image files stored in computer memory;
a computer processor communicatively coupled between the user interface, the display device and the computer memory; and
instructions stored in memory that, when executed, cause the processor to:
receive, via the user interface, initial product image selection information, the initial product image selection information being comprised of information identifying a plurality of product images to be displayed via a display device;
responsive to receiving the initial product image selection information, access a plurality of image files, each of the plurality of image files being stored in a computer memory,
wherein each of the plurality of image files comprises at least one product image, each product image presents a product in a predetermined product position in a non-virtual product space, at least the product images being captured by an image capture device;
identify from the plurality of image files, an initial set of product images, each product image of the initial set of product images comprising a respective product image identified in the initial product image selection information;
display, via the display device, a first composite image, the first composite image being comprised of the initial set of product images;
receive, via the user interface, replacement product image selection information, the replacement product image selection information comprising:
information identifying one or more product images of the initial set of product images that have been selected by a user to be replaced, and
a respective replacement product image therefor;
responsive to receiving the replacement product image selection information, access the plurality of image files;
identify from the plurality of image files, a replacement set of product images, each product image of the replacement set of product images being identified in either the initial product image selection information or the replacement product image selection information, each product image identified in the replacement product image selection information presents a replacement product in a predetermined product position in a non-virtual product space corresponding to the predetermined product position of the product presented in the product image identified in the initial product image selection information being replaced; and
display, via the display device, a second composite image, wherein the second composite image is comprised of the replacement set of product images.

18. Software stored in a non-transitory computer-readable medium and comprising instructions executable by a system, and in response to such execution causes the system to perform operations comprising:
receiving, via a user interface, initial product image selection information, the initial product image selection information being comprised of information identifying a plurality of product images to be displayed via a display device;
responsive to receiving the initial product image selection information, accessing, via a computer processor, a plurality of image files, each of the plurality of image files being stored in a computer memory,
wherein each of the plurality of image files comprises at least one product image, each product image presents a product in a predetermined product position in a non-virtual product space, at least the product images being captured by an image capture device;
identifying, via a computer processor, from the plurality of image files, an initial set of product images, each product image of the initial set of product images comprising a respective product image identified in the initial product image selection information;
displaying, via a display device, a first composite image, the first composite image being comprised of the initial set of product images;
receiving, via the user interface, replacement product image selection information, the replacement product image selection information comprising:
information identifying one or more product images of the initial set of product images that have been selected by a user to be replaced, and
a respective replacement product image therefor;
responsive to receiving the replacement product image selection information, accessing, via a computer processor, the plurality of image files;
identifying, via a computer processor, from the plurality of image files, a replacement set of product images, each product image of the replacement set of product images being identified in either the initial product image selection information or the replacement product image selection information, each product image identified in the replacement product image selection information presents a replacement product in a predetermined product position in a non-virtual product space corresponding to the predetermined product position of the product presented in the product image identified in the initial product image selection information being replaced; and
displaying, via a display device, a second composite image, wherein the second composite image is comprised of the replacement set of product images.
